(19) United States
(12) Patent Application Publication
(10) Pub. No.: US 2025/0060763 A1
(43) Pub. Date: Feb. 20, 2025

(54) HAIL STOW SYSTEM AND METHOD

(71) Applicant: Nextracker LLC, Fremont, CA (US)

(72) Inventors: Venkata Rahul Abbaraju, Fremont, CA (US); Rodrigo Javier Ramirez, Pleasanton, CA (US); Deepika Venkata Satya Durga Jyotula, San Jose, CA (US); Artin Azimi-Saravi, Los Gatos, CA (US); Jacob Taylor Butler, San Francisco, CA (US)

(21) Appl. No.: 18/807,109

(22) Filed: Aug. 16, 2024

Related U.S. Application Data
(60) Provisional application No. 63/520,560, filed on Aug. 18, 2023.

(51) Int. Cl. G05D 3/10; G01W 1/02; G01W 1/10; H02S 20/32

(52) U.S. Cl. CPC G05D 3/105; G01W 1/02; G01W 1/10; H02S 20/32; G01W 2203/00

(57) ABSTRACT

Systems and methods for triggering a stowing of one or more solar trackers comprise receiving weather data, the weather data including one or more hail parameters, determining the one or more hail parameters exceed a first corresponding one or more hail parameter thresholds, and triggering a stowing of one or more solar trackers. The one or more hail parameters include one or more of a probability of hail, a predicted size of hail, or a predicted location of hail. The systems and methods include one or more of determining the probability of hail exceeds the first hail probability threshold, determining the predicted size of hail exceeds the first hail size threshold, or determining the predicted location of hail exceeds the first threshold distance for trigging the stowing of the one or more solar trackers.

### RELATED APPLICATIONS

The present application claims the benefit of, and priority to, U.S. Provisional Patent Application Ser. No. 63/520,560, filed on Aug. 18, 2023, the entire content of which is hereby incorporated by reference in its entirety.

### TECHNICAL FIELD

The present disclosure generally relates to solar power generation systems, and more particularly, to solar trackers.

### BACKGROUND

Photovoltaic (PV) power systems are used to generate electrical power from solar energy and may include tracking systems to increase the amount of electrical power generated. PV systems that include tracking systems may be referred to as “solar trackers.” The tracking systems may enable solar modules to be rotated to track the sun as the sun moves across the sky.

Many solar trackers use solar modules comprising glass which is susceptible to damage from severe weather. For example, hail may cause damage to a solar module and render it inoperable or greatly diminish the solar module's ability to generate electrical power.

### SUMMARY

Aspects of the disclosure can include a hail stow system configured to receive weather data, determine a probability of hail exceeds a hail probability threshold, determine a predicted size of hail exceeds a hail size threshold, determine a predicted location of hail is within a threshold distance, determine a predicted hail time is within a threshold time, and trigger a stowing of one or more solar trackers.

In an example, a method for triggering a stowing of one or more solar trackers comprises receiving weather data, the weather data including one or more hail parameters, determining the one or more hail parameters exceed a first corresponding one or more hail parameter thresholds, and triggering a stowing of one or more solar trackers.

In an example, a system for stowing one or more solar trackers comprises one or more solar trackers including a drive mechanism configured to rotate the one or more solar trackers about an axis. The system also includes a controller in communication with the one or more solar trackers configured to: receive weather data, the weather data including one or more hail parameters, determine the one or more hail parameters exceed a first corresponding one or more hail parameter thresholds, and trigger a stowing of the one or more solar trackers to rotate the one or more solar trackers to a stow angle via the drive mechanism. These and other examples are described in the following disclosure.

### BRIEF DESCRIPTION OF THE DRAWINGS

FIG. 1 illustrates a perspective view of an example solar tracker according to an aspect of the present disclosure.

FIG. 2 illustrates an example graphical user interface including trigger conditions for triggering and un-triggering stowing of a solar tracker or solar array according to an aspect of the present disclosure.

FIG. 3 illustrates an example flow diagram for causing a solar tracker to stow according to an aspect of the present disclosure.

FIG. 4 illustrates an example flow diagram for causing a solar tracker to un-stow or return to normal operation according to an aspect of the present disclosure.

### DETAILED DESCRIPTION

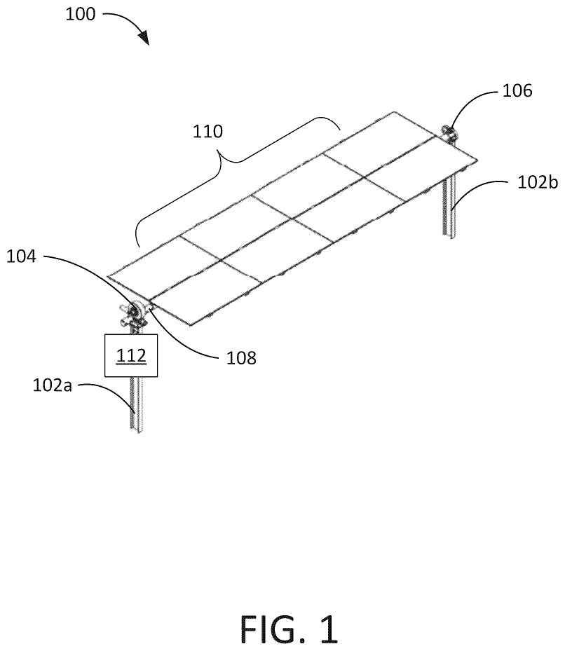

FIG. 1 illustrates a perspective view of an example solar tracker 100 according to an aspect of the present disclosure. The solar tracker 100 includes a first pier 102a and second pier 102b embedded in the ground. The solar tracker 100 also includes a drive mechanism 104 supported by the first pier 102a and a bearing 106 supported by the second pier 102b. A torque tube 108 extends from the drive mechanism 104 to the bearing 108. The torque tube 108 supports a plurality of solar panels 110 and can enable the plurality of solar panels 110 to rotate via the drive mechanism 104 and bearing 106 about an axis (e.g., a longitudinal axis). In some examples, a controller can be integrated with, or separate from, the solar tracker 100. The controller can communicate with the drive mechanism of the solar tracker 100 to cause the solar tracker 100 to rotate about an axis via the drive mechanism. In some examples, a plurality of solar trackers 100 can be arranged in a north-south longitudinal orientation to form a solar array. Throughout the present disclose, when referencing a solar array, a single solar tracker is also contemplated.

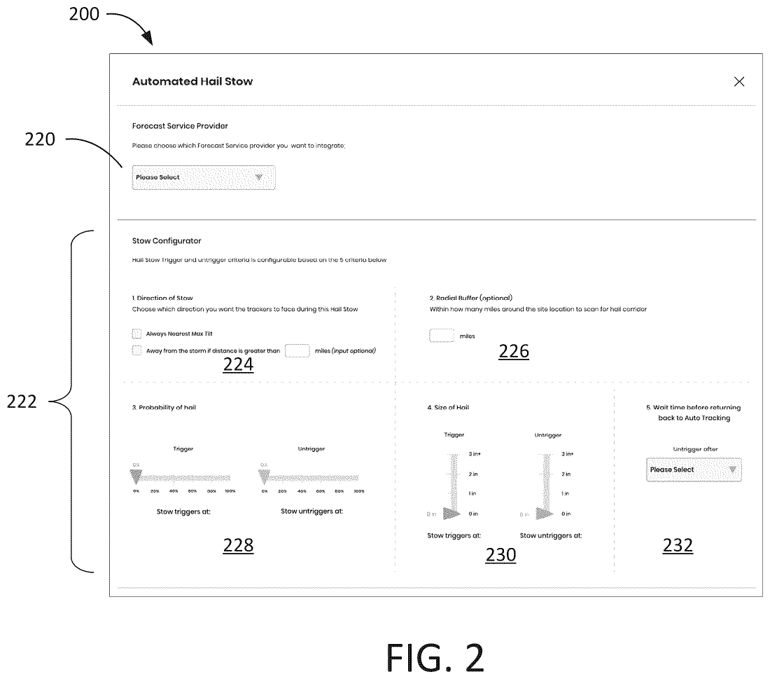

FIG. 2 illustrates an embodiment of graphical user interface (GUI) 200 including various trigger conditions for triggering and un-triggering stowing of a solar array according to an aspect of the present disclosure. Stowing can be defined as causing a solar tracker, or plurality of solar trackers (e.g., a solar array), to rotate to a desired angle, thereby causing the top of the solar modules to face the desired angle. In some examples, the desired angle can be referred to a as a stow angle. The stow angle can depend on various factors, however, in some examples, the stow angle is between −90 degrees and +90 degrees relative to horizontal. In some examples, the stow angle is approximately −75 degrees or approximately +75 degrees relative to horizontal. In some examples, the stow angle is approximately −60 degrees or approximately +60 degrees relative to horizontal. In some examples, the stow angle is approximately −50 degrees or approximately +50 degrees relative to horizontal. In some examples, the stow angle is between approximately −75 degrees and approximately −50 degrees relative to horizontal. Similarly, in some examples, the stow angle is between approximately +75 degrees and approximately +50 degrees relative to horizontal. In some examples where hail is not a concern, the stow angle is 0 degrees (e.g., parallel) to the horizontal.

The GUI includes a forecast service provider selector 220 and a stow configurator 222. The forecast service provider selector 220 enables a user to select from one or more weather service providers that generate a weather forecast and associated weather data. For example, a user can select from a first weather service provider that generally predicts more severe weather (e.g., hail, strong winds) rather than a second weather service provider that generally predicts less severe weather when a storm is predicted to encounter the location of a solar array. In some examples, in addition to or in lieu of using a forecast service provider, one or more sensing instruments 112 located proximate the solar array can be used to provide weather data. For example, the sensing instruments can include one or more temperature sensors, humidity sensors, atmospheric pressure sensors, precipitation sensors, wind sensors, impact sensors (e.g., hail impact sensors), radar (e.g., doppler radar), and the like. The weather data, provided by a forecast service provider and/or by sensing instruments, can include one or more hail parameters, such as the probability of hail, the predicted size of hail, and/or the predicted location of hail. The weather data can also be updated over time to included updated weather data. The updated weather data can similarly include one or more updated hail parameters, such as an updated probability of hail, an updated predicted size of hail, and an updated predicted location of hail.

The stow configurator 222 includes multiple sections of trigger conditions related to triggering and/or un-triggering stowing of a solar array. A first trigger condition can include a direction of stow 224 having a first option of nearest max-tilt and a second option of away from the storm. The first option of stowing nearest the max-tilt is based on the current angle of the solar array. For example, if the solar modules of the solar array are already rotated at an angle of +30 degrees relative to horizontal, stowing nearest the max-tilt would include rotating the faces of the solar modules to the maximum positive angle (e.g., +75 degrees relative to horizontal). Similarly, if the solar modules of the solar array are already rotated at an angle of −25 degrees relative to horizontal, stowing nearing the max-tilt would include rotating the faces of the solar modules to the maximum negative angle (e.g., −75 degrees relative to horizontal). By using the first option, the amount of time needed to rotate the solar modules is minimized as the solar array does not need to rotate through the 0 degree position before moving to the stow position.

In the example of FIG. 2, the second option of stowing away from the storm can include a user-defined distance. If the storm is further away than the user-defined distance, the solar trackers can be stowed in a direction away from the storm. However, if, for example, the storm is closer than the user-defined distance, the solar trackers might instead be stowed at the nearest max tilt. Stowing in a direction away from the storm can be based on the location of the storm, which refers to the center of the storm. In some examples, the center of the storm is determined by a snapshot of the weather forecast data read at a single time, relative to the location of the solar array (e.g., a center of the solar array). The center of the storm may only consider East and West components of the relative location. For example, the first option of stowing away from the storm refers to stowing opposite the direction of the storm's center, considering only whether the center of the storm is East or West from the solar array's location at the time of stowing. When stowing away from the storm, the faces of the solar modules of the solar array are rotated such that they face opposite the direction of the storm's center. By using the first option, damage to the solar modules of the solar array can be minimized.

The direction of movement of a storm relative to the project location is not considered in the example of FIG. 2. However, in some alternative embodiments, the direction of movement of the storm can also be considered when determining which direction to stow the solar modules. The direction of movement of the wind is also not considered in the example of FIG. 2. However, in some embodiments, the direction of the wind can also be considered when determining which direction to stow the solar modules.

Continuing with the stow configurator 222 of FIG. 2, a second trigger condition can include a radial buffer 226. The radial buffer 226 is a selected distance, measured radially from the location of the solar array, which potential hail or severe weather must be within or predicted within prior to trigger stowing of the solar trackers of the solar array. In the illustrated example, a user can input a number of miles into the radial buffer 226, however other distance measurements can be used. The radial buffer 226 of FIG. 2 is not by itself a trigger for causing stowing of the solar modules of the solar array. Instead, the radial buffer 226 is a trigger condition that is dependent on other trigger conditions being satisfied as discussed elsewhere herein. In some examples, a buffer that is not radial is used. In some examples, a predicted location of hail can be determined via the forecast service provider and/or by local instruments. The predicted location of hail can be considered a hail parameter.

A third trigger condition of FIG. 2 includes a probability of hail 228 expressed in a percentage (%). A user can select any probability of hail to occur between 0% and 100%. For example, a user can set a probability of 70% chance for hail for satisfying the trigger condition. In such an example, if the probability of hail is currently 50%, the trigger condition is not satisfied. However, if the probability increases to 75%, the trigger condition is satisfied. The probability of hail 228 can be determined via the forecast service provider 220 and/or by local instruments. The probability of hail can be considered a hail parameter.

A fourth trigger condition of FIG. 2 includes a size of hail 230, which is a minimum size of potential hail that will satisfy the trigger condition. A user can select different sizes of hail within a range between zero inches and three inches. In some examples, the range is larger or smaller than the illustrated range of FIG. 2. In FIG. 2, a user can select a size of hail for triggering a stow to be 1.5 inches. In such an example, if the size of hail is predicted to be 1.7 inches, the fourth trigger condition is satisfied. The size of hail 230 can be determined via the forecast service provider 220 and/or by local instruments. The size of hail can also be considered a hail parameter.

In some examples, an additional trigger condition includes a time for next hail which is a time within which the potential hail must be predicted to occur. In some such examples, a user can select or input times that outline the trigger condition. For example, a user can select a time of 30 minutes for satisfying the trigger condition. In such an example, if hail is predicted to occur within the next 20 minutes (e.g., at the location of the solar array), the trigger condition is satisfied. The time for the next hail 232 can be determined via the forecast service provider 220 and/or by local instruments. The time for the next hail can also be considered a hail parameter.

In the example of FIG. 2, the second, third, and fourth trigger conditions are considered together. Accordingly, weather data, which can be analyzed each time the system receives new/updated weather data, must satisfy all four trigger conditions to trigger a stow. In accordance with the example of FIG. 2, a snapshot of weather data is analyzed each time new/updated weather data is received, such as every minute or every several minutes. If during any snapshot, the probability of hail is predicted to be a size equal to or larger than the minimum trigger size 230, at a time equal to or less than the trigger time 232, and at a location anywhere within the maximum radial distance 226, is equal to or exceeds the minimum probability 228 set by a user, the solar tracker(s) of a solar array will be stowed either away from the storm or to the nearest max-tilt in accordance with the user's selection (e.g., due East or due West).

However, in some examples, not all the trigger conditions need to be satisfied to trigger a stow. For instance, when one or more trigger conditions are satisfied, a solar tracker is triggered into being stowed. One such example can be the size of hail being larger than a user-specified diameter. In such an example, if the predicted size of hail is larger than three inches in diameter (as set by the user), the trigger condition is satisfied and a solar tracker is triggered into being stowed, regardless of whether other trigger conditions are satisfied.

Continuing with the example of FIG. 2, a second, third, fourth, and fifth un-trigger condition can be used to un-trigger a stow of solar trackers of a solar array. Un-triggering can be defined as causing one or more solar trackers (e.g., of a solar array) to return to a normal operation/normal operating position from a stowed position. For example, if solar trackers of a solar array are in a stowed position of −75 degrees or +75 degrees relative to horizontal, an un-trigger causes the solar trackers to return to tracking a position of the sun to generate electrical energy. In some examples, the second, third, fourth, and fifth un-trigger conditions are considered together, whereby all the un-trigger conditions have to be satisfied to cause an un-triggering of solar trackers. However, in some examples, only one or more of the second, third, fourth, and fifth un-trigger conditions are used to un-trigger the solar trackers. In some examples, the second, third, fourth, and fifth un-trigger conditions can be separate from, or integrated with, the second third, fourth, and fifth trigger conditions.

The radial buffer 226 can be used as a second un-trigger condition. In some examples, a radial buffer, separate from the radial buffer 226 is used as an un-trigger condition. A user can input a number of miles into the radial buffer that potential hail or severe weather must be outside to satisfy the un-trigger condition.

The probability of hail 228 includes a third un-trigger condition. In similarity with the third trigger condition, a user can input a probability in percent for satisfying the un-trigger condition. For example, a user can set the un-trigger probability of hail to 30%. If the probability of hail falls below 30% (e.g., after hail has already passed over the solar array), the un-trigger condition is. The un-trigger condition probability of FIG. 2 is separate from the trigger condition probability, but need not be (e.g., same percentage for trigger and un-trigger).

The size of hail 230 includes a fourth un-trigger condition. In similarity with the fourth trigger condition, a user can input a size of hail for satisfying the un-trigger condition. For example, a user can set an un-trigger size of hail to be 0.6 inches in diameter. If the predicted size of hail is 0.5 inches (e.g., after the hail has passed or if conditions change before the hail reaches the solar array), the un-trigger condition is satisfied.

A wait time before returning to auto tracking 232 can include a fifth un-trigger condition, whereby when the wait time expires, the wait time un-trigger condition is satisfied. A user can input and/or select a wait time, for example, in increments of 15 minutes (e.g., one hour 15 minutes). In the example of FIG. 2, the wait time is considered an additional un-trigger condition that needs to be satisfied before solar trackers return to normal operation (e.g., auto tracking). For instance, even if all other un-trigger conditions are satisfied, solar trackers will not return to normal operation until expiry of the user-defined wait time. In some examples, the wait time is started after all other un-triggers are met. The wait time can prevent excessive triggering/un-triggering of stowing solar trackers.

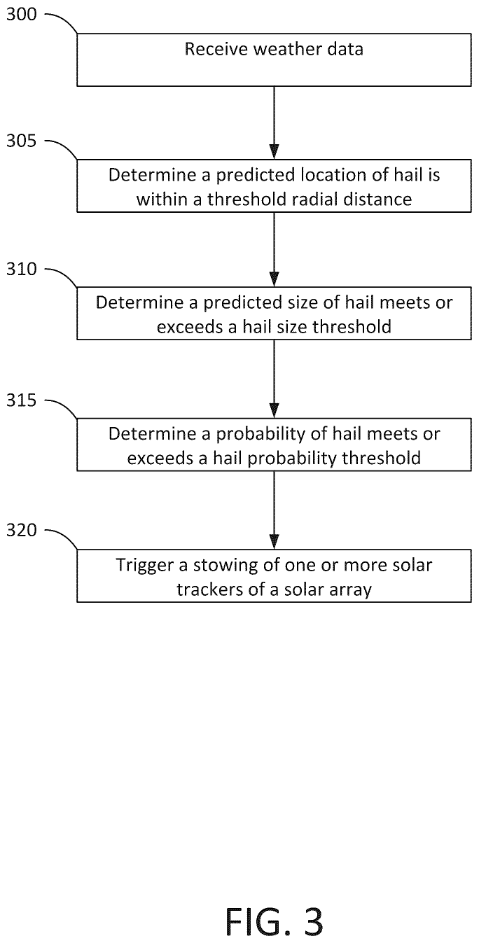

FIG. 3 illustrates a flow diagram of a method of causing a solar tracker to stow according to an aspect of the present disclosure. The method can start at 300 whereby weather data is received, with the weather data including predictive weather data. The predictive weather data can include a predicted location of hail, a predicted probability of hail (e.g., for a location), a predicted size of hail, and a predicted time of hail (e.g., for a location). The weather data can be received from a weather service provider (e.g., 220 of FIG. 2) and/or from local instruments. At 305, the method includes determining a predicted location of hail exceeds (e.g., is within) a threshold radial distance. At 310, the method includes determining a predicted size of hail meets or exceeds a hail size threshold. At 315, the method includes determining a probability of hail meets or exceeds a hail probability threshold. The steps of 305-15 positively determine that their respective criteria are met. Accordingly, at step 320, the method includes triggering a stowing of one or more solar trackers of a solar array. As discussed elsewhere herein, the stowing can include stowing the one or more solar trackers away from the storm or stowing them at the nearest maximum tilt.

While the example method of FIG. 3 illustrates that all trigger conditions need to be satisfied before triggering a stowing of one or more solar trackers (e.g., as in steps 305-315), in some examples, only one or more trigger conditions need to be satisfied to trigger a stowing of the one or more solar trackers.

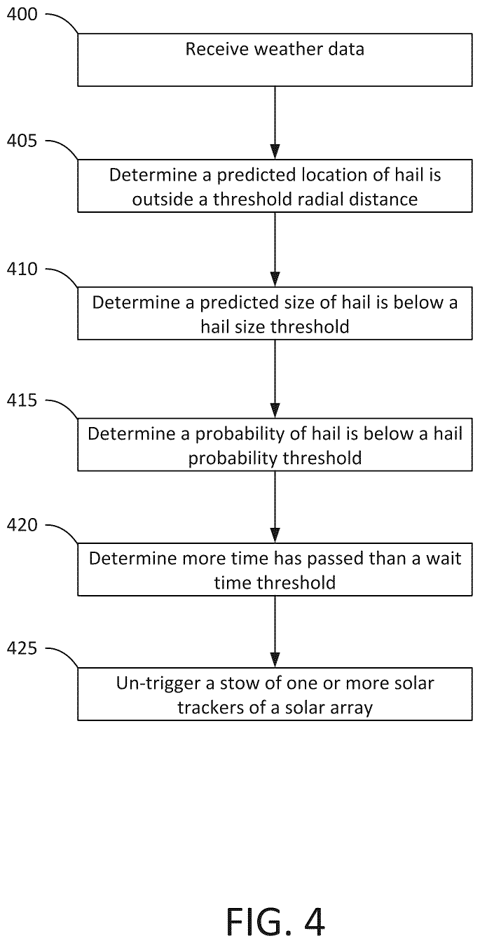

FIG. 4 illustrates a flow diagram of a method of causing a solar tracker to un-stow or return to normal operation according to an aspect of the present disclosure. The method can start at 400 whereby weather data is received, with the weather data including predictive weather data. The predictive weather data can include a predicted location of hail, a predicted probability of hail (e.g., for a location), a predicted size of hail, and a predicted time of hail (e.g., for a location). The weather data can be received from a weather service provider (e.g., 220 of FIG. 2) and/or from local instruments. At 405, the method includes determining a predicted location of hail is outside a threshold radial distance. At 410, the method includes determining a predicted size of hail is below a hail size threshold. At 415, the method includes determining a probability of hail is below a hail probability threshold. At 420, the method includes determining that more time has passed than a wait time threshold. In some examples, the time that has passed in step 420 is started when the conditions of 405-415 have been satisfied. The steps of 405-420 positively determine that their respective criteria are met. Accordingly, at step 425, the method includes un-triggering a stow of one or more solar trackers of a solar array. As discussed elsewhere herein, the un-stowing can include returning the one or more solar trackers to normal operation (e.g., tracking the sun). In some examples, the steps of FIG. 4 are performed after the steps of FIG. 3 are performed. For example, one or more solar trackers may be stowed due to criteria in FIG. 3 to protect the one or more solar trackers from hail damage. Subsequently, the one or more solar trackers may be un-stowed or returned to normal operation based on the criteria of FIG. 4 (e.g., the threat of hail damage has passed).

While the example method of FIG. 4 illustrates that all un-trigger conditions need to be satisfied before un-triggering a stow of one or more solar trackers (e.g., as in steps 405-420), in some examples, only one or more un-trigger conditions need to be satisfied to un-trigger a stow of the one or more solar trackers.

The method steps of FIG. 3 and FIG. 4 are illustrated as occurring in a specific order, however, in some examples, one or more of the steps occur in a different order than illustrated. For instance, in some examples, the determining steps of FIG. 3 and FIG. 4 can occur in any order. Additionally, in some examples, one or more of the steps occur simultaneously as one or more other steps.

Various non-limiting embodiments have been described. These and others are within the scope of the following claims.

1. A method for triggering a stowing of one or more solar trackers comprising:
receiving weather data, the weather data including one or more hail parameters;
determining the one or more hail parameters exceed a first corresponding one or more hail parameter thresholds; and
triggering a stowing of one or more solar trackers.

2. The method of claim 1, wherein:
the one or more hail parameters include one or more of:
a probability of hail;
a predicted size of hail; or
a predicted location of hail;
the first corresponding one or more hail parameter thresholds include one or more of:
a first hail probability threshold;
a first hail size threshold; or
a first threshold distance.

3. The method of claim 2, wherein the determining the one or more hail parameters exceed the first corresponding one or more hail parameter thresholds comprises one or more of:
determining the probability of hail exceeds the first hail probability threshold;
determining the predicted size of hail exceeds the first hail size threshold; or
determining the predicted location of hail exceeds the first threshold distance.

4. The method of claim 3, wherein determining the predicted size of hail exceeds the first hail size threshold triggers the stowing of the one or more solar trackers.

5. The method of claim 1, wherein the weather data is received from a forecast service provider and/or one or more sensing instruments.

6. The method of claim 1, wherein triggering a stowing of the one or more solar trackers causes the one or more solar trackers to rotate to a stow angle.

7. The method of claim 6, wherein the stow angle is between −90 degrees and +90 degrees relative to horizontal.

8. The method of claim 7, wherein the stow angle is either between −75 degrees and −50 degrees or between +75 degrees and +50 degrees relative to horizontal.

9. The method of claim 1, further comprising:
determining a current angle of the one or more solar trackers; and
determining whether a first stow angle or a second stow angle is closer to the current angle of the one or more solar trackers; wherein
triggering the stowing of the one or more solar trackers causes the one or more solar trackers to rotate to a closer of the first stow angle or the second stow angle relative to the current angle of the one or more solar trackers.

10. The method of claim 1, wherein:
the weather data includes a direction of travel for weather; and
triggering the stowing of the one or more solar trackers causes the one or more solar trackers to rotate to a stow angle, the stow angle being in a direction away from the direction of travel of the weather.

11. The method of claim 1, further comprising:
receiving updated weather data including updated hail parameters;
determining one or more of the updated hail parameters are within a second corresponding one or more hail parameter thresholds; and
un-triggering a stowing of the one or more solar trackers.

12. The method of claim 11, wherein un-triggering the stowing of one or more solar trackers causes the one or more solar trackers to return to a normal operation from a stowed position.

13. The method of claim 11, wherein:
the second corresponding one or more hail parameter thresholds are different than the first corresponding one or more hail parameter thresholds and include one or more of:
a second hail probability threshold;
a second hail size threshold; or
a second threshold distance.

14. The method of claim 13, wherein the determining the one or more of the updated hail parameters are within the second corresponding one or more hail parameter thresholds comprises one or more of:
determining an updated probability of hail is within the second hail probability threshold;
determining an updated predicted size of hail is within the second hail size threshold; and
determining an updated predicted location of hail is within the second threshold distance.

15. The method of claim 11, further comprising waiting for a first time before un-triggering the stowing of the one or more solar trackers.

16. A system for stowing one or more solar trackers comprising:
one or more solar trackers including a drive mechanism configured to rotate the one or more solar trackers about an axis;
a controller in communication with the one or more solar trackers configured to:
receive weather data, the weather data including one or more hail parameters;
determine the one or more hail parameters exceed a first corresponding one or more hail parameter thresholds; and
trigger a stowing of the one or more solar trackers to rotate the one or more solar trackers to a stow angle via the drive mechanism.

17. The system of claim 16, wherein:
the one or more hail parameters include one or more of:
a probability of hail;
a predicted size of hail;
or a predicted location of hail;
the first corresponding one or more hail parameter thresholds include one or more of:
a first hail probability threshold;
a first hail size threshold;
or a first threshold distance.

18. The system of claim 17, wherein the controller, in determining the one or more hail parameters exceed the first corresponding one or more hail parameter thresholds, is configured to:
determine the probability of hail exceeds the first hail probability threshold;
determine the predicted size of hail exceeds the first hail size threshold; and/or
determine the predicted location of hail exceeds the first threshold distance.

19. The system of claim 16, wherein the controller is further configured to:
receive updated weather data including updated hail parameters;
determine one or more of the updated hail parameters are within a second corresponding one or more hail parameter thresholds, each of the second corresponding one or more hail parameter thresholds being different than each of the first corresponding one or more hail parameter thresholds;
un-trigger a stowing of the one or more solar trackers to rotate the one or more solar trackers to a normal operating position from the stow angle.

20. The system of claim 19, wherein each of the second corresponding one or more hail parameter thresholds is different than each of the first corresponding one or more hail parameter thresholds.
